(19) United States
(12) Patent Application Publication
(10) Pub. No.: US 2023/0078244 A1
(43) Pub. Date: Mar. 16, 2023

(54) FAT FREE, NON-DAIRY SOFT SERVE COMPOSITIONS

(71) Applicant: The Coca-Cola Company, Atlanta, GA (US)

(72) Inventors: Dhaval Patel, Winter Garden, FL (US); Bolivar Cevallos, Logwood, FL (US)

(21) Appl. No.: 17/802,252

(22) PCT Filed: Mar. 3, 2021
(86) PCT No.: PCT/US2021/020662

§ 371 Date: Aug. 25, 2022

Related U.S. Application Data
(60) Provisional application No. 62/984,547, filed on Mar. 3, 2020.

(51) Int. Cl. A23G 9/42; A23G 9/34; A23G 9/52

(52) U.S. Cl. CPC A23G 9/42; A23G 9/34; A23G 9/52

(57) ABSTRACT

Fat free, non-dairy soft serve premixes comprising one or more juice concentrates and/or fruit puree concentrate, at least one plant extract rich in saponins, pectin and at least one thickener are provided herein, as well as methods of preparing said premixes. Fat free, non-dairy soft serve products and methods of preparing fat free, non-dairy soft serve products from said premixes are also provided.

### CROSS REFERENCE TO RELATED APPLICATION

This application claims priority to U.S. Provisional Patent Application No. 62/984,547, filed Mar. 3, 2020, the contents of which are incorporated herein.

### FIELD OF THE INVENTION

Disclosed herein are fat free, non-dairy soft serve premixes; fat free, non-dairy soft serve products prepared from said premixes and methods of preparing fat free, non-dairy soft serve products from said premixes. The fat free, non-dairy soft serve products disclosed herein have improved overrun compared to conventional, dairy-containing soft serve products.

### BACKGROUND OF THE INVENTION

A traditional soft-serve product contains dairy products and is generally lower in milk-fat (3% to 6%) than ice cream (10% to 18%). Alternative, similar frozen desserts are known that are entirely non-dairy (“non-dairy soft-serve products”). Both the non-dairy and dairy products are produced at a temperature of about −4° C. compared to ice cream, which is stored at −15° C. These products contain air, introduced at the time of freezing.

Soft serve products are drawn from a freezing cylinder or chamber at intermittent times, e.g. at the point of sale. A server or consumer serves the product by drawing it through a dispensing mechanism to a receptacle, e.g., bowls, cups or cones. The product must be in a proper state for serving when it is needed. To achieve this, soft serve premix (kept in a storage chamber at 3° C. (37° F.)) and air are fed into a freezer, where the mixture is frozen to a semi-solid consistency and moved or beaten with beaters and/or scraping blades so that a continuous folding or blending of the nearly frozen mixture occurs in the freezing cylinder, and the material (as it freezes in the freezing cylinder) is whisked or scraped off and dropped back into the mixture for further blending and movement within the cylinder. Both gravity style freezers and pressurized freezers are known in the art. Pressurized freezers provide superior air incorporation (i.e., overrun) compared to gravity freezers.

Conventionally, the amount of air (i.e., overrun) in the soft serve product alters taste and texture. Product with low quantities of air has a heavy, icy taste and appears more yellow. Product with higher air content tastes creamier, smoother and lighter and appears whiter. Conventional, dairy-containing soft serve is usually dispensed at an overrun on the order of 40% to 60%.

A distinction between soft-serve products (e.g. Dairy Queen®) and “regular” aerated frozen desserts such as ice cream or sherbets is that soft-serve is intended for immediate consumption following preparation while “regular” aerated frozen desserts are intended for consumption upon removal from extended frozen storage. While desirably soft upon aeration and freezing, soft serve products undesirably develop large ice crystals upon extended frozen storage compared to “regular” aerated frozen desserts. Formation of large ice crystals can be aggravated by fluctuations in storage temperature. Negative sensory characteristics in soft serve products usually result from such perceived body or textural defects.

There remains a need to provide fat free, non-dairy soft serve products with increased overrun and more particularly, superior textural and sensory characteristics.

### SUMMARY OF THE INVENTION

In one aspect, a fat free, non-dairy soft serve premix composition is disclosed comprising at least one fruit juice concentrate, fruit puree concentrate or combination thereof; at least one plant extract rich in saponins; pectin and at least one thickener.

In another embodiment, a fat free, non-dairy soft serve premix is disclosed in the form of a liquid soft serve premix comprising water; at least one fruit juice concentrate, fruit puree concentrate or combination thereof; at least one plant extract rich in saponins; pectin and at least one thickener.

In another embodiment, a fat free, non-dairy soft serve premix is disclosed in the form of a powder soft serve premix comprising at least one dehydrated fruit juice concentrate, dehydrated fruit puree concentrate or combination thereof; at least one plant extract rich in saponins; pectin and at least one thickener.

The weight ratio of the pectin to the at least one thickener in the fat free, non-dairy soft serve premix is at least about 0.75. Surprisingly, it has been found that having at least this weight ratio provides superior overrun when the premix is formed into the product. In particular, fat free, non-dairy soft serve products having about 70% overrun or more can be achieved.

In one embodiment, the fat free, non-dairy soft serve premix has no added sugar. In another embodiment, the fat free, non-dairy soft serve premix comprises one or more caloric or non-caloric sweeteners.

The fat free, non-dairy soft serve premixes optionally include one or more flavor agents, color agents and/or fruit acids.

In a second aspect, a fat free, non-dairy soft serve product is disclosed, prepared from the fat free, non-dairy soft serve premix disclosed herein. The fat free, non-dairy soft serve product comprises air; at least one fruit juice concentrate, fruit puree concentrate or combination thereof; at least one plant extract rich in saponins; pectin and at least one thickener.

In one embodiment, the fat free, non-dairy soft serve product has an overrun of at least about 70%. In another embodiment, the fat free, non-dairy soft serve product has a weight ratio of pectin to at least one thickener of at least about 0.75. In a more particular embodiment, the fat free, non-dairy soft serve product has an overrun of at least about 70% and a weight ratio of pectin to at least one thickener of at least about 0.75.

In one embodiment, the fat free, non-dairy soft serve product has no added sugar. In another embodiment, a fat free, non-dairy soft serve product comprises one or more caloric or non-caloric sweetener.

The fat free, non-dairy soft serve product optionally includes one or more flavor agents, color agents and/or fruit acids.

In a third aspect, disclosed herein is a method of preparing a liquid fat free, non-dairy soft serve premix comprising combining water; at least one fruit juice concentrate, fruit puree concentrate or combination thereof; at least one plant extract rich in saponins; pectin and at least one thickener, thereby providing a liquid fat free, non-dairy soft serve premix.

In one embodiment, the combining comprises (a) providing a volume of water and (b) adding premix ingredients to said volume of water, wherein the premix ingredients comprise at least one fruit juice concentrate, fruit puree concentrate or combination thereof; at least one plant extract rich in saponins; pectin and at least one thickener, thereby providing a fat free, non-dairy liquid soft serve premix.

In a fourth aspect, disclosed herein is a method of preparing a fat free, non-dairy powder soft serve premix comprising (i) combining at least one dehydrated fruit juice concentrate, fruit puree concentrate or combination thereof; at least one plant extract rich in saponins; pectin and at least one thickener, thereby providing a fat free, non-dairy powder soft serve premix.

In one embodiment, the combining in (i) comprises (a) providing a fat free, non-dairy liquid soft serve premix as described above and (b) dehydrating the premix, i.e., removing the water, thereby providing a fat free, non-dairy powder soft serve premix.

In a fifth aspect, disclosed herein is a method of preparing a fat free, non-dairy soft serve product from the soft serve premixes described herein. In one embodiment, a method is disclosed of preparing a fat free, non-dairy soft serve product comprising (i) introducing a fat free, non-dairy liquid soft serve premix disclosed herein into a refrigerated storage tank of a soft serve machine maintained at a temperature from about 2° C. to about 4° C., (ii) introducing the fat free, non-dairy liquid soft serve premix and a volume of air from the refrigerated storage tank into the freezer of the soft serve machine equipped with beaters and/or scraping blades, wherein the beaters and/or scraping blades continually blend the liquid soft serve premix and air, thereby providing a fat free, non-dairy soft serve product. The method can further comprise (iii) dispensing at least a portion of the fat free, non-dairy soft serve product.

### BRIEF DESCRIPTION OF THE DRAWINGS

FIG. 1. shows a pie chart reflecting the results of a consumer sensory study focused on aftertaste of a strawberry soft serve product, as described in Example 3. No aftertaste (hashed), pleasant aftertaste (dark), and unpleasant aftertaste (light).

FIG. 2. shows a pie chart reflecting the results of a consumer sensory study focused on aftertaste of a mango soft serve product, as described in Example 3. No aftertaste (hashed), pleasant aftertaste (dark), and unpleasant aftertaste (light).

### DETAILED DESCRIPTION OF THE INVENTION

### I. Definitions

“Non-dairy”, as used herein, refers to the absence of milk and milk-derived components. Non-dairy premixes and non-dairy soft-serve products are characterized in part by an absence of any milk-derived components including milk or butterfat, non-fat milk solids or sugars, milk derived proteins such as whey solids or caseinate. Such compositions are particularly useful for consumption by individuals having lactose intolerance.

“Overrun”, as used herein, refers to the amount of air incorporated in a soft serve composition. Overrun is expressed as a percentage and refers to the relative volumes of air and premix. For example, a soft serve composition in which the volume of air is exactly equal to the volume of premix is said to have 100% overrun. When overrun is properly incorporated, it is in the form of finely divided and evenly distributed air cells that help provide structure and creaminess to the composition. The air cells are dispersed in the liquid portion, which contains the other ingredients of the soft serve composition.

“Soft serve”, as used herein, refers to an aerated frozen dessert similar to ice cream but softer and less dense as a result of air being introduced during freezing.

“Non-dairy soft serve”, as used herein, refers to an aerated frozen dessert similar to ice cream but softer and less dense as a result of air being introduced during freezing, wherein the dessert does not contain milk or milk-derived components, as set forth above.

“Fat free”, as used herein, refers to the absence of fat components.

### II. Soft Serve Premix

In a first aspect, a fat free, non-dairy soft serve premix composition is disclosed that is useful for preparation of a fat free, non-dairy soft serve product.

The soft serve premix composition can be in the form of a powder premix, a liquid premix or an ultra-heat treated premix (also called a “shelf stable” premix). The powder premix is the dried or dehydrated form of the liquid premix, i.e. the liquid premix contains water and the powder premix does not contain water.

In one embodiment, the fat free, non-dairy soft serve premix comprises water; at least one fruit juice concentrate, fruit puree concentrate or combination thereof; at least one plant extract rich in saponins; pectin and at least one thickener.

In another embodiment, the fat free, non-dairy soft serve premix comprises at least one dehydrated fruit juice concentrate, dehydrated fruit puree concentrate or combination thereof; at least one plant extract rich in saponins; pectin and at least one thickener.

The fruit is provided in the form of a fruit juice concentrate, fruit puree concentrate or a combination of fruit juice concentrate and fruit puree concentrate. The juice or concentrate can be from any fruit. Exemplary fruits include, but are not limited to, apple, apricot, avocado, banana, blackberry, black currant, blueberry, breadfruit, cantaloupe, carambola, cherimoya, cherry, clementine, coconut, cranberry, custard-apple, date, durian, elderberry, feijoa, fig, gooseberry, grapefruit, grape, guava, honeydew melon, jackfruit, java-plum, jujube fruit, kiwifruit, kumquat, lemon, lime, longan, loquat, lychee, mandarin, mango, mangosteen, mulberry, nectarine, orange, papaya, passion fruit, peach, pear, persimmon, pitaya (dragonfruit), pineapple, pitanga, plantain, plum, pomegranate, prickly pear, prune, pummelo, quince, raspberry, rhubarb, rose-apple, sapodilla, sapote, soursop, strawberry, sugar-apple, tamarine, tangerine, watermelon and combinations thereof. The fruit juice concentrate can be prepared or purchased from a commercial source.

Fruit juice can contain up to 90% water. The water content of fruit juice concentrate is significantly reduced, producing a syrup. The water content of the fruit juice concentrate will vary depending on the starting fruit juice and method of concentration (e.g. evaporation or vacuum). Generally, the content of water in the fruit juice concentrate is from about 30% to about 40%.

Fruit purees can be advantageous because they provide a texture closer to intact fruit in the soft serve product.

In one particular embodiment, a fat free, non-dairy liquid soft serve premix comprises at least one fruit juice concentrate, fruit puree concentrate or combination thereof, wherein the fruit is selected from the group consisting of strawberry, mango, apple, pear, white grape juice and combinations thereof.

In another particular embodiment, a fat free, non-dairy liquid strawberry soft serve premix is disclosed comprising strawberry juice concentrate and optionally one or more additional fruit juice concentrate, fruit puree concentrate or combination thereof. In a preferred embodiment, the fat free, non-dairy liquid strawberry soft serve premix comprises strawberry juice concentrate, apple juice concentrate, pear juice concentrate and white grape juice concentrate.

In another particular embodiment, a fat free, non-dairy liquid mango soft serve premix is disclosed comprising mango puree concentrate, and optionally one or more additional fruit puree concentrate, fruit juice concentrate or combination thereof. In a preferred embodiment, the fat free, non-dairy liquid mango soft serve premix comprises mango puree concentrate, apple juice concentrate, pear juice concentrate and white grape juice concentrate.

The amount of the at least one fruit juice concentrate, fruit puree concentrate or combination thereof in the liquid soft serve premix is from about 15% to about 50% by weight, such as, for example, from about 15% to about 40%, from about 15% to about 30%, from about 15% to about 20%, from about 20% to about 40%, from about 20% to about 30%, from about 25% to about 50%, from about 25% to about 40%, from about 25% to about 30%, from about 30% to about 50%, from about 30% to about 40%, from about 35% to about 50% or from about 40% to about 50%. In a preferred embodiment, the fat free, non-dairy liquid soft serve premix comprises from about 20% to about 40% at least one fruit juice concentrate, fruit puree concentrate or combination thereof, even more preferably from about 20% to about 30%, still more preferably from about 20% to about 25%

The at least one saponin functions as a foaming agent when the premix is formulated into a fat free, non-dairy soft serve product. Saponins are glycosidic natural plant products comprising an aglycone ring structure and one or more sugar moieties. The combination of the nonpolar aglycone and the water-soluble sugar moiety gives saponins surfactant properties, which allow them to form a foam when shaken in an aqueous solution.

The saponins are grouped together based on several common properties. The types of aglycone ring structures forming the ring structure in saponins can vary greatly. Non-limiting examples of the types of aglycone ring structures in saponin for use in particular embodiments of the compositions and methods disclosed herein include steroids, triterpenoids, and steroidal alkaloids. Steroidal saponins are mainly compounds containing 27 carbon atoms forming the core structures: spirostan (16β,22:22α,26-diepoxy-cholestan) and furostan (16β,22-epoxycholestan). There are 11 main classes of saponins: dammaranes, tirucallanes, lupanes, hopanes, oleananes, taraxasteranes, ursanes, cycloartanes, lanostanes, cucurbitanes, and steroids. The oleanane skeleton is the most common, present in most orders of the Plant Kingdom. Saponins with the carbohydrate or oligosaccharide groups attached at the C-3 position are monodesmosidic, while saponins with carbohydrates attached at both the C-3 and C-26 or C-28 positions are bidesmosidic. The variety of a glycones, carbohydrates, and different attachment positions result in numerous types of saponins. The carbohydrate chains of saponins usually include: D-glucose, D-galactose, L-rhamnose, L-arabinose, D-xylose, D-apiose, D-fucose, and D-glucuronic acid. The steroidal saponins usually show furostanol or spirostanol form. Additionally, both steroidal and triterpene saponins may contain other functional groups: —OH, —COOH, —CH₃ that give them additional diversity.

Saponins are provided in the form of a plant extra rich in saponins. Exemplary plant extracts rich in saponins include, but are not limited to, horse chestnut (Aesculis hipocastanum), oat (Avena sativa), sugar beet leaves (Beta vulgaris), quinoa (Chenopodium quinoa), chickpea (Cicer arietinum), saffron crocus (Crocus savitus), soybean (Glycine max), licorice root (Glycyrrhiza glabbra), ivy (Hedera helix), alfalfa (Medicago sativa), Chinese ginseng (Panax ginseng), American ginseng (Panax quinquefolius), green pea (Pisum sativum), milkwort (Polygala spp.), primula (Primula spp.), quillaja bark (Quillaja saponaria), soapwort (Saponaria officinalis), sarsaparilla (Smilax officinalis), fenugreek (Trigonellafoenum-graecum) and yucca (Yucca schidigera).

In a preferred embodiment, the at least one plant extract rich in saponins is selected from quillaja bark extract, yucca extract and a combination thereof.

The amount of the at least one plant extract rich in saponins in the fat free, non-dairy liquid soft serve premix is from about 0.01% to about 0.1% by weight, such as, for example, from about 0.01% to about 0.08%, from about 0.01% to about 0.07%, from about 0.01% to about 0.06%, from about 0.01% to about 0.05%, from about 0.01% to about 0.04%, from about 0.01% to about 0.03% or from about 0.01% to about 0.02%.

Pectin is a gelling agent that improves viscosity and texture when the fat free, non-dairy premix is formulated into a fat free, non-dairy soft serve product, particularly in combination with the at least one thickener in certain amounts. Pectin can be provided in either liquid or dry form.

Pectin is a polysaccharide starch found in the cell walls of fruits and vegetables. Pectin can be sourced from a wide variety of fruits and vegetables including, but not limited to, apples, citrus fruits (oranges, grapefruits, lemon and lime), carrots, apricots, plums, blackberries, cherries and quince. The amount of pectin found in fruits and vegetables will vary considerably. As a general rule, firmer fruits have high pectin levels, while squishy fruits have lower levels. Ripe fruits also have lower pectin levels than unripe ones.

There are four main types of pectin: high methoxyl pectin, low methoxyl pectin, apple pectin and pectin NH.

High methoxyl (HM) pectin is the most common type of pectin, labeled as either “rapid-set” or “slow-set.” Both types are extracted from citrus fruit peels, with the main difference being how much time and the temperature they take to set. Rapid-set pectin takes a higher temperature and less time to set, while slow-set pectin takes a lower temperature and more time to set.

Low methoxyl pectin (LM) also comes from citrus peels. It is often used for low-calorie jams and jellies since it relies on calcium instead of sugar to solidify. It can be used for dairy-based recipes that do not require sugar. LM pectin grows increasingly more firm as calcium is added until it hits a saturation point. At that time, the process reverses, and it becomes less firm.

Apple pectin is pectin that is derived from apples and usually sold as a powder. It can be used as a gelling and thickening agent, as well as a food stabilizer. Apple pectin contains healthy carbohydrates, dietary fiber, sodium, manganese, copper, and zinc.

Pectin NH is an apple pectin typically used for fruit glazes and fruit fillings. Like any other type of LM pepctin, pectin NH needs calcium to gel, but less of it. It is also thermally reversible, which means that it can be melted, set, re-melted, and then reset again.

In the disclosed fat free, non-dairy soft serve premix compositions, the pectin can be any type of pectin described above or a combination thereof, i.e., the pectin is selected from the group consisting of high methoxyl pectin, low methoxyl pectin, apple pectin, pectin NH and a combination thereof. In a preferred embodiment, the pectin is high methoxyl pectin.

The amount of pectin in the fat free, non-dairy liquid soft serve premix is from about 0.1% to about 1% by weight, such as, for example, from about 0.1% to about 0.8%, from about 0.1% to about 0.5%, from about 0.1% to about 0.3%, from about 0.2% to about 1%, from about 0.2% to about 0.8%, from about 0.2% to about 0.5%, from about 0.3% to about 1%, from about 0.3% to about 0.8%, from about 0.3% to about 0.5%, from about 0.4% to about 1%, from about 0.4% to about 0.8%, from about 0.4% to about 0.5%, from about 0.5% to about 1% and from about 0.5% to about 0.8%.

In more particular embodiments, the total pectin content of a fat free, non-dairy liquid soft serve premix in an amount from 0.27% to about 0.40% or from about 0.29% to about 0.38%. “Total pectin content” refers to added pectin (as an ingredient) and any pectin inherently present in the fruit juice concentrate or fruit puree concentrate. For example, mango puree concentrate contains a pectin content of about 0.083%. Accordingly, in one embodiment, a fat free, non-dairy mango liquid soft serve premix contains about 0.38% total pectin content.

In other more particular embodiments, the pectin is present in a fat free, non-dairy liquid soft serve premix in an amount from about 0.4% to about 0.5%. In a more particular embodiment, the fat free, non-dairy liquid soft serve premix is a strawberry soft serve premix, as discussed above.

The at least one thickener improves viscosity and texture, and additionally aids in emulsification when the fat free, non-dairy premix is formulated into a fat free, non-dairy soft serve product, particularly in combination with the pectin in certain amounts.

Exemplary thickeners include, but are not limited to, alginic acids (alginic acid, sodium alginate, etc.), xanthan gum, guar gum, tara gum, locust bean gum, tamarind seed gum, psyllium seed gum, water-soluble soybean polysaccharide, gum arabic, tragacanth gum, karaya gum, pectin, gluco Mannan, carrageenan, agar, gellan gum, native gellan gum, curdlan, pullulan, macrohomopsis gum, rhamzan gum, methylcellulose (MC), hydroxypropylmethylcellulose (HPMC), cellulose derivatives such as sodium carboxymethylcellulose (CMC), microcrystalline cellulose and gellan gum.

In preferred embodiments, the at least one thickener is a gum. In one embodiment, the at least one thickener is a gum selected from xanthan gum, gum arabic and a combination thereof.

The amount of the at least one thickener in the fat free, non-dairy liquid soft serve premix is from about 0.1% to 1% by weight, such as, for example, from about 0.1% to about 0.8%, from about 0.1% to about 0.5%, from about 0.1% to about 0.3%, from about 0.2% to about 1%, from about 0.2% to about 0.8%, from about 0.2% to about 0.5%, from about 0.3% to about 1%, from about 0.3% to about 0.8%, from about 0.3% to about 5%, from about 0.4% to about 1%, from about 0.4% to about 0.8%, from about 0.4% to about 0.5%, from about 0.5% to about 1% and from about 0.5% to about 0.8%. In preferred embodiments, the amount of pectin in the fat free, non-dairy liquid soft serve premix is from about 0.2% to about 0.8%, more preferably from about 0.2% to about 0.5% or from about 0.3% to about 0.7%.

It has surprisingly been found that the ratio of pectin to at least one thickener in the premix impacts the overrun of the resulting fat free, non-dairy soft serve product. In particular, fat free, non-dairy soft serve products having about 70% overrun or more can be prepared from premixes of the present invention having weight ratios of pectin (i.e. added pectin, as a single ingredient) to at least one thickener of at least about 0.75 (see examples), such as, for example, from about 0.75 to about 1.0, from about 0.75 to about 0.9, from about 0.75 to about 0.85 and from about 0.75 to about 0.80.

Higher levels of overrun can also be achieved with the fat free, non-dairy soft serve premixes of the present invention, i.e. an overrun of 75% or greater, an overrun of 80% or greater, an overrun of 85% or greater, an overrun of 90% or greater or an overrun of 95% or greater.

The fat free, non-dairy liquid soft serve premix also contains water separate from the water provided by the fruit juice concentrate and/or puree. The amount of water in the fat free, non-dairy liquid soft serve premix is from about 50% to about 80% by weight, such as, for example, from about 50% to about 75%, from about 50% to about 70%, from about 50% to about 60%, from about 50% to about 55%, from about 55% to about 80%, from about 55% to about 75%, from about 55% to about 70%, from about 55% to about 65%, from about 55% to about 60%, from about 60% to about 80%, from about 60% to about 75%, from about 60% to about 70%, from about 60% to about 65%, from about 65% to about 80%, from about 65% to about 75%, from about 65% to about 70%, from about 70% to about 80% and from about 75% to about 80%.

In one embodiment, a fat free, non-dairy liquid soft serve premix is disclosed comprising water; at least one fruit concentrate, fruit puree concentrate or combination thereof; at least one plant extract rich in saponins, pectin and at least one thickener, wherein the weight ratio of the pectin to at least one thickener is at least about 0.75.

In another particular embodiment, a fat free, non-dairy liquid soft serve premix is disclosed comprising water; at least one fruit juice concentrate, fruit puree concentrate or combination thereof selected from the group consisting of strawberry juice concentrate, mango puree concentrate, apple juice concentrate, pear juice concentrate, white grape juice concentrate and combinations thereof; at least one plant extract rich in saponins; pectin and at least one thickener, wherein the weight ratio of the pectin to at least one thickener is at least about 0.75.

In another particular embodiment, a fat free, non-dairy liquid soft serve premix is disclosed comprising water; at least one fruit juice concentrate, fruit puree concentrate or combination thereof; at least one plant extract rich in saponins selected from quillaja bark extract, yucca extract and a combination thereof; pectin and at least one thickener, wherein the weight ratio of the pectin to at least one thickener is at least about 0.75.

In another particular embodiment, a fat free, non-dairy liquid soft serve premix is disclosed comprising water; at least one fruit juice concentrate, fruit puree concentrate or combination thereof; at least one plant extract rich in saponins; pectin and at least one thickener selected from xanthan gum, gum arabic and a combination thereof, wherein the weight ratio of the pectin to at least one thickener is at least about 0.75.

In one embodiment, a fat free, non-dairy liquid soft serve premix is disclosed comprising, by weight, from about 50% to about 80% water; from about 15% to about 50% at least one fruit juice, fruit puree concentrate or combination thereof; from about 0.01% to about 0.1% at least one plant extract rich in saponins; from about 0.1% to about 1% pectin and from about 0.1% to about 1% at least one thickener, wherein the weight ratio of the pectin to at least one thickener is at least about 0.75.

In another more particular embodiment, a fat free, non-dairy strawberry liquid soft serve premix is disclosed comprising water; strawberry juice concentrate and, optionally, one or more additional fruit juice concentrate, fruit puree concentrate or combination thereof; at least one plant extract rich in saponins; pectin and at least one thickener, wherein the weight ratio of the pectin to at least one thickener is at least about 0.75.

In one embodiment, a fat free, non-dairy strawberry liquid soft serve premix is disclosed comprising water; strawberry juice concentrate and, optionally, one or more additional fruit juice concentrate, fruit puree concentrate or combination thereof; at least one plant extract rich in saponins; pectin and at least one thickener, wherein the weight ratio of the pectin to at least one thickener is at least about 0.75 and the amount of the at least one thickener is at least about 0.55% by weight.

In another more particular embodiment, a fat free, non-dairy strawberry liquid soft serve premix is disclosed comprising water; strawberry juice concentrate and, optionally, one or more additional fruit juice concentrate, fruit puree concentrate or a combination thereof; at least one plant extract rich in saponins; pectin and at least one thickener, wherein the weight ratio of the pectin to at least one thickener is at least about 0.75 and the amount of pectin is at least about 0.44% by weight.

In an even more particular embodiment, a fat free, non-dairy strawberry liquid soft serve premix is disclosed comprising water; strawberry juice concentrate and, optionally, one or more additional fruit juice concentrate, fruit puree concentrate or combination thereof; at least one plant extract rich in saponins; pectin and at least one thickener, wherein the weight ratio of the pectin to at least one thickener is at least about 0.75, the amount of pectin is at least about 0.44% by weight and the at least one thickener is at least about 55% by weight.

In still another more particular embodiment, a fat free, non-dairy strawberry liquid soft serve premix is disclosed comprising water; strawberry juice concentrate and, optionally, one or more additional fruit juice concentrate, fruit puree concentrate or combination thereof; at least one plant extract rich in saponins; pectin and at least one thickener, wherein the weight ratio of the pectin to at least one thickener is at least about 0.80 and the amount of at least one thickener is at least about 0.55% by weight.

In yet another more particular embodiment, a fat free, non-dairy strawberry liquid soft serve premix is disclosed comprising water; strawberry juice concentrate and, optionally, one or more additional fruit juice concentrate, fruit puree concentrate or combination thereof; at least one plant extract rich in saponins; pectin and at least one thickener, wherein the weight ratio of the pectin to at least one thickener is at least about 0.80 and the amount of pectin is at least about 0.44% by weight.

In a further more particular embodiment, a fat free, non-dairy strawberry liquid soft serve premix is disclosed comprising water; strawberry juice concentrate and, optionally, one or more additional fruit juice concentrate, fruit puree concentrate or combination thereof; at least one plant extract rich in saponins; pectin and at least one thickener, wherein the weight ratio of the pectin to at least one thickener is at least about 0.80, the amount of at least one thickener is at least about 0.55% by weight and the amount of pectin is at least about 0.44% by weight.

In a more particular embodiment, a fat free, non-dairy mango liquid soft serve premix is disclosed comprising water; mango puree concentrate and, optionally, one or more additional fruit puree concentrate, fruit juice concentrate or combination thereof; at least one plant extract rich in saponins; pectin and at least one thickener, wherein the weight ratio of the pectin to at least one thickener is at least about 0.75.

In one embodiment, a fat free, non-dairy mango liquid soft serve premix is disclosed comprising water; mango puree concentrate and, optionally, one or more additional fruit puree concentrate, fruit juice concentrate or combination thereof; at least one plant extract rich in saponins; pectin and at least one thickener, wherein the weight ratio of the pectin to at least one thickener is at least about 0.75 and the amount of the at least one thickener is at least about 0.39% by weight.

In another embodiment, a fat free, non-dairy mango liquid soft serve premix is disclosed comprising water; mango puree concentrate and, optionally, one or more additional fruit puree concentrate, fruit juice concentrate or combination thereof; at least one plant extract rich in saponins; pectin and at least one thickener, wherein the weight ratio of the pectin to at least one thickener is at least about 0.75 and the amount of pectin is at least about 0.29% by weight.

In a more particular embodiment, a fat free, non-dairy mango liquid soft serve premix is disclosed comprising water; mango puree concentrate and, optionally, one or more additional fruit puree concentrate, fruit juice concentrate or combination thereof; at least one plant extract rich in saponins; pectin and at least one thickener, wherein the weight ratio of the pectin to at least one thickener is at least about 0.75, the amount of the at least one thickener is at least about 0.39% by weight and the amount of pectin is at least about 0.29% by weight.

Fat free, non-dairy powder soft serve premixes of the present invention contain all of the same ingredients as the fat free, non-dairy liquid soft serve premixes of the present invention—with the exception of water. Accordingly, a fat free, non-dairy powder soft serve premix of the present invention comprises at least one dehydrated fruit juice concentrate, dehydrated fruit puree concentrate or combination thereof at least one plant extract rich in saponins; pectin and at least one thickener.

In one particular embodiment, a fat free, non-dairy powder soft serve premix is disclosed comprising at least one dehydrated fruit juice concentrate, dehydrated fruit puree concentrate or combination thereof selected from the group consisting of dehydrated strawberry juice concentrate, dehydrated mango puree concentrate, dehydrated apple juice concentrate, dehydrated pear juice concentrate, dehydrated white grape juice concentrate and combinations thereof.

In another particular embodiment, a fat free, non-dairy powder strawberry soft serve premix is disclosed comprising dehydrated strawberry juice concentrate, and optionally one or more additional dehydrated fruit juice concentrate, dehydrated fruit puree concentrate or a combination thereof. In a preferred embodiment, a fat free, non-dairy powder strawberry soft serve premix comprises dehydrated strawberry juice concentrate, dehydrated apple juice concentrate, dehydrated pear juice concentrate and dehydrated white grape juice concentrate.

In another particular embodiment, a fat free, non-dairy powder mango soft serve premix is disclosed comprising dehydrated mango puree concentrate and, optionally one or more additional dehydrated fruit puree concentrate, dehydrated fruit juice concentrate or a combination thereof. In a preferred embodiment, a fat free, non-dairy powder mango soft serve premix comprises dehydrated mango puree concentrate, dehydrated apple juice concentrate, dehydrated pear juice concentrate and dehydrated white grape juice concentrate.

In certain embodiments, the amount of the at least one dehydrated fruit juice concentrate, dehydrated fruit puree concentrate or combination thereof in the fat free, non-dairy powder soft serve premix is from about 60% to about 70% by weight.

In certain embodiments, the amount of the at least one plant extract rich in saponins in the fat free, non-dairy powder soft serve premix is from about 0.04% to about 0.09% by weight.

In certain embodiments, the amount of the pectin in the fat free, non-dairy powder soft serve premix is from about 1.25% to about 1.85% by weight.

In certain embodiments, the amount of the at least one thickener in the fat free, non-dairy powder soft serve premix is from about 1.5% to about 2.0% by weight.

In certain embodiments, the ratio of pectin to at least one thickener is still desirably at least 0.75 in the premix to achieve a soft serve overrun of about 70% or more.

In one embodiment, a fat free, non-dairy powder soft serve premix is disclosed comprising at least one dehydrated fruit juice concentrate, dehydrated fruit puree concentrate or a combination thereof; at least one plant extract rich in saponin; pectin and at least one thickener, wherein the weight ratio of the pectin to at least one thickener is at least about 0.75.

In another particular embodiment, a fat free, non-dairy powder soft serve premix is disclosed comprising at least one dehydrated fruit juice concentrate, dehydrated fruit puree concentrate or a combination thereof selected from the group consisting of strawberry juice concentrate, mango puree concentrate, apple juice concentrate, pear juice concentrate and white grape juice concentrate; at least one plant extract rich in saponins; pectin and at least one thickener, wherein the weight ratio of the pectin to at least one thickener is at least about 0.75.

In another particular embodiment, a fat free, non-dairy powder soft serve premix is disclosed comprising at least one dehydrated fruit juice concentrate, dehydrated fruit puree concentrate or a combination thereof; at least one plant extract rich in saponins selected from quillaja bark extract, yucca extract and a combination thereof; pectin and at least one thickener, wherein the weight ratio of the pectin to at least one thickener is at least about 0.75.

In another particular embodiment, a fat free, non-dairy powder soft serve premix is disclosed comprising at least one dehydrated fruit juice concentrate, dehydrated fruit puree concentrate or combination thereof; at least one plant extract rich in saponins; pectin and at least one thickener selected from xanthan gum, gum arabic and a combination thereof, wherein the weight ratio of the pectin to at least one thickener is at least about 0.75.

In one embodiment, a fat free, non-dairy powder soft serve premix is disclosed comprising, by weight, from about 60% to about 70% at least one fruit juice concentrate, dehydrated fruit puree concentrate or combination thereof; from about 0.04% to about 0.09% at least one plant extract rich in saponins, from about 1.25% to about 1.85% pectin and from about 1.5% to about 2.0% at least one thickener, wherein the weight ratio of the pectin to at least one thickener is at least about 0.75.

In one embodiment, a fat free, non-dairy strawberry powder soft serve premix is disclosed comprising dehydrated strawberry juice concentrate and, optionally, one or more additional dehydrated fruit juice concentrate, fruit puree concentrate or combination thereof; at least one plant extract rich in saponins; pectin and at least one thickener, wherein the weight ratio of the pectin to at least one thickener is at least about 0.75.

In a more particular embodiment, a fat free, non-dairy strawberry powder soft serve premix is disclosed comprising dehydrated strawberry juice concentrate and, optionally, one or more additional dehydrated fruit juice concentrate, dehydrated fruit puree concentrate or combination thereof; at least one plant extract rich in saponins; pectin and at least one thickener, wherein the weight ratio of the pectin to at least one thickener is at least about 0.75 and the amount of the at least one thickener is at least about 1.90% by weight.

In another more particular embodiment, a fat free, non-dairy strawberry powder soft serve premix is disclosed comprising dehydrated strawberry juice concentrate and, optionally, one or more additional dehydrated fruit juice concentrate, dehydrated fruit puree concentrate or combination thereof; at least one plant extract rich in saponins; pectin and at least one thickener, wherein the weight ratio of the pectin to at least one thickener is at least about 0.75 and the amount of pectin is at least about 1.70% by weight.

In one embodiment, a fat free, non-dairy mango powder soft serve premix is disclosed comprising dehydrated mango puree concentrate and, optionally, one or more additional dehydrated fruit puree concentrate, dehydrated fruit juice concentrate or combination thereof; at least one plant extract rich in saponins; pectin and at least one thickener, wherein the weight ratio of the pectin to at least one thickener is at least about 0.75.

In a more particular embodiment, a fat free, non-dairy mango powder soft serve premix is disclosed comprising dehydrated mango puree concentrate and, optionally, one or more additional dehydrated fruit puree concentrate, dehydrated fruit juice concentrate or combination thereof; at least one plant extract rich in saponins; pectin and at least one thickener, wherein the weight ratio of the pectin to at least one thickener is at least about 0.75 and the amount of the at least one thickener is at least about 1.30% by weight.

In another more particular embodiment, a fat free, non-dairy mango powder soft serve premix is disclosed comprising dehydrated mango puree concentrate and, optionally, one or more additional dehydrated fruit puree concentrate, dehydrated fruit juice concentrate or combination thereof; at least one plant extract rich in saponins; pectin and at least one thickener, wherein the weight ratio of the pectin to at least one thickener is at least about 0.75 and the amount of pectin is at least about 1.65% by weight.

In preferred embodiments, the fat free, non-dairy soft serve premixes disclosed herein (liquid or powder) have no sugar added. In other embodiments, the soft serve premixes disclosed herein contain one or more sweeteners. The sweetener can be caloric or non-calorie.

In certain embodiments, the sweetener can be a natural sweetener, a natural high potency sweetener or synthetic sweetener. As used herein, the phrase “natural high potency sweetener” (NHPS) refers to any sweetener found naturally in nature and characteristically has a sweetness potency greater than sucrose, fructose, or glucose, yet has less calories. The natural high potency sweetener can be provided as a pure compound or, alternatively, as part of an extract. As used herein, the phrase “synthetic sweetener” refers to any composition which is not found naturally in nature and characteristically has a sweetness potency greater than sucrose, fructose, or glucose, yet has less calories.

Non-limiting examples of NHPSs includes stevia and steviolglycosides, such as rebaudioside M, rebaudioside D, rebaudioside A, rebaudioside N, rebaudioside O, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, enzymatically glucosylated steviol glycosides and combinations thereof.

Another exemplary NHPS is Luo Han Guo and the related mogroside compounds, such as grosmogroside I, mogroside IA, mogroside IE, 11-oxomogroside IA, mogroside II, mogroside II A, mogroside II B, mogroside II E, 7-oxomogroside II E, mogroside III, Mogroside IIIe, 11-oxomogroside IIIE, 11-deoxymogroside III, mogroside IV, Mogroside IVA 11-oxomogroside IV, 11-oxomogroside IVA, mogroside V, isomogroside V, 11-deoxymogroside V, 7-oxomogroside V, 11-oxomogroside V, isomogroside V, mogroside VI, mogrol, 11-oxomogrol, siamenoside I, isomers of siamenoside I (e.g. those disclosed in 20170119032; incorporated by reference in its entirety), (3β, 9β, 10α, 11α, 24R)-3-[(4-O-β-D-glucospyranosyl-6-O-β-D-glucopyranosyl]-25-hydroxyl-9-methyl-19-norlanost-5-en-24-yl-[2-O-β-D-glucopyranosyl-6-O-β-D-glucopyranosyl]-β-D-glucopyranoside); (3β, 9β, 10α, 11α, 24R)-[(2-O-β-D-glucopyranosyl-6-O-β-D-glucopyranosyl-β-D-glucopyranosyl)oxy]-25-hydroxy-9-methyl-19-norlanost-5-en-24-yl-[2-O-β-D-glucopyranosyl-6-O-β-D-glucopyranosyl]-β-D-glucopyranoside); and (3β, 9β, 10α, 11α, 24R)-[(2-O-β-D-glucopyranosyl-6-O-β-D-glucopyranosyl-β-D-glucopyranosyl)oxy]-25-hydroxy-9-methyl-19-norlanost-5-en-24-yl-[2-O-β-D-glucopyranosyl-6-O-β-D-glucopyranosyl]-β-D-glucopyranoside),

Other exemplary NHPSs include monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

In one embodiment, the sweetener is a carbohydrate sweetener. Suitable carbohydrate sweeteners include, but not limited to, the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

Other suitable sweeteners include siamenoside, monatin and its salts (monatin SS, RR, RS, SR), curculin, mogrosides, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, steviolbioside and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

In one embodiment, the sweetener is a caloric sweetener or mixture of caloric sweeteners. In another embodiment, the caloric sweetener is selected from sucrose, fructose, glucose, high fructose corn/starch syrup, a beet sugar, a cane sugar, and combinations thereof.

In another embodiment, the sweetener is a rare sugar selected from allulose, gulose, kojibiose, sorbose, lyxose, ribulose, xylose, xylulose, D-allose, L-ribose, D-tagatose, L-glucose, L-fucose, L-arabinose, turanose and combinations thereof.

The soft serve premixes disclosed herein (liquid or powder) can, optionally, further include one or more flavor agents, color agents and/or fruit acids.

Suitable flavoring agents can include any natural or artificial flavor desired and may range from single fruit flavors such as peach, apricot, raspberry, lemon, strawberry, cherry, blueberry, pineapple, orange, vanilla, banana, coconut, chocolate, chocolate mint, chocolate mocha, etc. and blends thereof.

Suitable color agents can include any approved ingredient. Exemplary color agents include, anthocyanins, betacyanins, annatto extract, dehydrated beets (beet powder), canthaxanthin, caramel, 3-Apo-8′-carotenal, β-carotene, cochineal extract, carmine, sodium copper chlorophyllin, toasted partially defatted cooked cottonseed flour, ferrous gluconate, ferrous lactate, grape color extract, grape skin extract (enocianina), synthetic iron oxide, fruit juice, vegetable juice, carrot oil, paprika, paprika oleoresin, mica-based pearlescent pigments, riboflavin, saffron, spirulina extract, titanium dioxide, tomato lycopene extract or concentrate, turmeric, turmeric oleoresin, FD&C Blue No. 1, FD&C Blue No. 2, FD&C Green No. 3, Orange B, Citrus Red No. 2, FD&C Red No. 3, FD&C Red No. 40, FD&C Yellow No. 5, FD&C Yellow No. 6 and blends thereof.

In acidic fruit flavor soft serve formulations, it is desired to enhance the acidity and tartness of the flavor. In such cases, from 0.1 up to about 0.5% by weight of a fruit acid such as citric acid, malic acid or tartaric acid, may be added to the composition. In addition, a certain amount of the sodium salt of the acid, from about 0.01 to 0.15% by weight, can also be utilized for flavor balance and buffering.

### III. Soft Serve Product

In a second aspect, disclosed herein is a fat free, non-dairy soft serve product prepared from the soft serve premixes described herein and incorporating air. The overrun achieved by the disclosed fat free, non-dairy soft serve products is surprisingly high, e.g. at least about 70%. Higher overrun can also be achieved, e.g. at least about 75%, at least about 80%, at least about 90% or at least about 95%.

Not wishing to be bound by theory, it is believed that when the soft serve premix enters the freezing barrel, small air cells are rapidly and continuously generated by the whipping motion. Freezing creates small ice crystals, rearranges soluble solids and increases viscosity. The at least one thickener, which function as stabilizers, form a three-dimensional network to stabilize air cells and ice crystals. The hydrophobic peptide chains of the at least one thickener (e.g. gums) adsorb onto the air cells, while the hydrophobic blocks inhibit flocculation via electrostatic and stearic repulsions. Pectin provides viscosity, helps develop the three-dimensional network via interaction with the at least one thickener (e.g. gums) and traps the whipped air. This mechanism, similar to formation of an air micelle around the ice crystal, in combination with increase viscosity affected by freezing, provides increased stability in the resulting soft serve product. “Stability” in this context refers to the ability of a soft serve product to maintain the creamy, frozen structure without rapidly melting and collapsing. In one embodiment, the fat free, non-dairy soft serve products of the present invention have improved stability.

In one embodiment, a fat free, non-dairy soft serve product is disclosed comprising at least one fruit juice concentrate, fruit puree concentrate or a combination thereof; at least one plant extract rich in saponins; pectin; at least one thickener and air, wherein the soft serve product has an overrun of at least about 70%, such as, for example, at least about 75%, at least about 80%, at least about 85%, at least about 90% or at least about 95%.

In another embodiment, the fat free, non-dairy soft serve product has an overrun from about 70% to about 95%, such as, for example, from about 70% to about 90%, from about 70% to about 85%, from about 70% to about 80%, from about 70% to about 75%, from about 75% to about 95%, from about 75% to about 90%, from about 75% to about 85%, from about 75% to about 80%, from about 80% to about 95%, from about 80% to about 90%, from about 80% to about 85%, from about 85% to about 95%, from about 85% to about 90% or from about 90% to about 95%.

In one embodiment, the fat free, non-dairy soft serve product disclosed herein contains no added sugar.

The fat free, non-dairy soft serve product disclosed herein contains the same at least one fruit juice concentrate, fruit puree concentrate or combination thereof; at least one plant extract rich in saponins; pectin and at least one thickener as the fat free, non-dairy soft serve premix, discussed above. The fat free, non-dairy soft serve product additionally contains air.

In one particular embodiment, a fat free, non-dairy soft serve product is disclosed comprising at least one fruit juice concentrate, fruit puree concentrate or combination thereof selected from the group consisting of strawberry juice concentrate, mango puree concentrate, apple juice concentrate, pear juice concentrate and white grape juice concentrate.

In another particular embodiment, a fat free, non-dairy strawberry soft serve product is disclosed comprising strawberry juice concentrate and optionally one or more additional fruit juice concentrate, fruit puree concentrate or combination thereof. In a preferred embodiment, a fat free, non-dairy strawberry soft serve product comprises strawberry juice concentrate, apple juice concentrate, pear juice concentrate and white grape juice concentrate.

In another particular embodiment, a fat free, non-dairy mango soft serve product is disclosed comprising mango puree concentrate and optionally one or more additional fruit puree concentrate, fruit juice concentrate or combination thereof. In a preferred embodiment, a fat free, non-dairy mango soft serve product comprises mango puree concentrate, apple juice concentrate, pear juice concentrate and white grape juice concentrate.

In certain embodiments, the amount of the at least one fruit juice concentrate, fruit puree concentrate or combination thereof in the fat free, non-dairy soft serve product is from about 1% to about 8%.

The at least one plant extract rich in saponins can be any plant extract described above for the fat free, non-dairy soft serve premix. In a particular embodiment, the fat free, non-dairy soft serve product comprises at least one plant extract rich in saponins selected from quillaja bark extract, yucca extract and a combination thereof.

In certain embodiments, the amount of the at least one plant extract rich in saponins in the fat free, non-dairy soft serve product is from about 0.005% to about 0.012%.

The pectin can be any pectin described above for the fat free, non-dairy soft serve premix. In a particular embodiment, the pectin is high methoxyl pectin.

In certain embodiments, the amount of pectin in the fat free, non-dairy soft serve product is from about 0.05% to about 0.15%.

The at least one thickener can be any thickener described above for the fat free, non-dairy soft serve premix. In a particular embodiment, the fat free, non-dairy soft serve product comprises at least one thickener is selected from xanthan gum, gum arabic and a combination thereof.

In certain embodiments, the amount of the at least one thickener in the fat free, non-dairy soft serve product is from about 0.10% to about 0.20%.

As described above, the ratio of pectin to the at least one thickener impacts the overrun of the resulting fat free, non-dairy soft serve product. In particular, soft serve products having about 70% overrun or more can be prepared from soft serve premixes of the present invention having weight ratios of pectin (i.e. added pectin) to at least one stabilizer of at least about 0.75 (see examples), such as, for example, from about 0.75 to about 1.0, from about 0.75 to about 0.9, from about 0.75 to about 0.85 and from about 0.75 to about 80.

In one embodiment, a fat free, non-dairy soft serve product is disclosed comprising air; at least one fruit juice concentrate, fruit puree concentrate or a combination thereof; at least one plant extract rich in saponins; pectin and at least one thickener, wherein the weight ratio of the pectin to at least one thickener is at least about 0.75 and the overrun is at least about 70%.

In another particular embodiment, a fat free, non-dairy soft serve product is disclosed comprising air; at least one fruit juice concentrate, fruit puree concentrate or combination thereof selected from the group consisting of strawberry juice concentrate, mango puree concentrate, apple juice concentrate, pear juice concentrate and white grape juice concentrate; at least one plant extract rich in saponins; pectin and at least one thickener, wherein the weight ratio of the pectin to at least one thickener is at least about 0.75 and the overrun is at least about 70%.

In another particular embodiment, a fat free, non-dairy soft serve product is disclosed comprising air; at least one fruit juice concentrate, fruit puree concentrate or combination thereof; at least one plant extract rich in saponins selected from quillaja bark extract, yucca extract and a combination thereof; pectin and at least one thickener, wherein the weight ratio of the pectin to at least one thickener is at least about 0.75 and the overrun is at least about 70%.

In another particular embodiment, a fat free, non-dairy soft serve product is disclosed comprising air; at least one fruit juice concentrate, fruit puree concentrate or combination thereof; at least one plant extract rich in saponins; pectin and at least one thickener selected from xanthan gum, gum arabic and a combination thereof, wherein the weight ratio of the pectin to at least one thickener is at least about 0.75 and the overrun is at least about 70%.

In one embodiment, a fat free, non-dairy soft serve product cis disclosed comprising, by weight, from about 70% to about 90% air; from about 2% to about 8% at least one fruit juice concentrate, fruit puree concentrate or combination thereof; from about 0.005% to about 0.01% at least one plant extract rich in saponins; from about 0.05% to about 0.5% pectin and from about 0.05% to about 0.5% at least one thickener, wherein the weight ratio of the pectin to at least one thickener is at least about 0.75 and the overrun is at least about 70%.

In one embodiment, a fat free, non-dairy strawberry soft serve product is disclosed comprising air; strawberry juice concentrate and, optionally, one or more additional fruit juice concentrate, fruit puree concentrate or combination thereof; at least one plant extract rich in saponins; pectin and at least one thickener, wherein the weight ratio of the pectin to at least one thickener is at least about 0.75 and the overrun is at least about 70%.

In a more particular embodiment, a fat free, non-dairy strawberry soft serve product is disclosed comprising air; strawberry juice concentrate and, optionally, one or more additional fruit juice concentrate, fruit puree concentrate or combination thereof; at least one plant extract rich in saponin; pectin and at least one thickener, wherein the weight ratio of the pectin to at least one thickener is at least about 0.80 and the overrun is at least about 70%.

In a still more particular embodiment, a fat free, non-dairy strawberry soft serve product is disclosed comprising air; strawberry juice concentrate and, optionally, one or more additional fruit juice concentrate, fruit puree concentrate or combination thereof; at least one plant extract rich in saponins; pectin and at least one thickener, wherein the weight ratio of the pectin to at least one thickener is at least about 0.80 and the overrun is at least about 75%.

In a more particular embodiment, a fat free, non-dairy mango soft serve product is disclosed comprising air; mango puree concentrate and, optionally, one or more additional fruit puree concentrate, fruit juice concentrate or combination thereof; at least one plant extract rich in saponins; pectin and at least one thickener, wherein the weight ratio of the pectin to at least one thickener is at least about 0.75 and the overrun is at least about 70%.

The fat free, non-dairy soft serve products disclosed herein can further include one or more flavor agents, color agents and/or fruit acids, described above for the fat free, non-dairy soft serve premix. The fat free, non-dairy soft serve products can also contain any sweetener (natural, synthetic, caloric or non-caloric) described above for the fat free, non-dairy soft serve premix.

The fat free, non-dairy soft serve products disclosed herein preferably contain about 50 calories or less, such as, for example, about 40 calories or less, about 30 calories or less, about 20 calories or less, about 10 calories or less or about 5 calories or less. In some embodiments, the soft serve products are non-caloric, i.e. contain zero calories.

### IV. Method of Preparing Soft Serve Premix and Soft Serve Product

In a third aspect, method is disclosed of preparing a fat free, non-dairy soft serve premix.

In one embodiment, a method of preparing a fat free, non-dairy liquid soft serve premix comprises combining water; at least one fruit juice concentrate, fruit puree concentrate or a combination thereof; at least one plant extract rich in saponins; pectin and at least one thickener, thereby providing a fat free, non-dairy liquid soft serve premix.

The at least one fruit juice concentrate and/or fruit puree concentrate, at least one plant extract rich in saponins, pectin and at least one thickener can be any of the types describes above with respect to the premixes.

The water, at least one fruit juice concentrate and/or fruit puree concentrate, at least one plant extract rich in saponins, pectin and at least one thickener can be added in any order. In one embodiment, a method for preparing a fat free, non-dairy liquid soft serve premix comprises (i) providing a volume of water and (ii) adding premix ingredients to said volume of water, wherein the premix ingredients comprise at least one fruit juice concentrate, fruit puree concentrate or a combination thereof; at least one plant extract rich in saponins; pectin and at least one thickener, thereby providing a fat free, non-dairy liquid soft serve premix.

In a particular embodiment, the at least one thickener is added first, followed by the at least one fruit juice concentrate and/or fruit puree concentrate. The at least one plant extract rich in saponins is typically added last to minimize foaming upon mixing.

In some embodiments, the premix ingredients further comprise one or more flavor agents, color agents, fruit acids and/or sweeteners.

The method optionally further comprises a mixing step (iii) after the premix ingredients have been added to the water.

In some embodiments, the method further comprises heating the fat free, non-dairy liquid soft serve premix to promote dissolution of all ingredients in the water. The fat free, non-dairy liquid soft serve premix can then be cooled to room temperature or below, more preferably about 4° C. or below for storage.

In a fourth aspect, a method is disclosed of preparing a fat free, non-dairy powder soft serve premix.

In one embodiment, a method of preparing a fat free, non-dairy powder soft serve premix is disclosed comprising (i) providing a fat free, non-dairy liquid soft serve premix as described above and (ii) dehydrating the premix, i.e., removing the water, thereby providing a powder soft serve premix. Dehydration can be performed by any method known in the art, e.g. spray drying, evaporation, vacuum, distillation.

In another embodiment, a method of preparing a fat free, non-dairy powder soft serve premix is disclosed comprising combining premix ingredients, i.e. combining at least one dehydrated fruit concentrate, fruit puree concentrate or a combination thereof; at least one plant extract rich in saponins; pectin and at least one thickener, thereby providing a fat free, non-dairy powder soft serve premix. The premix ingredients optionally include one or more flavor agents, color agents, fruit acids and/or sweeteners.

The at least one dehydrated fruit juice concentrate and/or fruit puree concentrate, at least one plant extract rich in saponins, pectin and at least one thickener can be any of the types describes above with respect to the premixes. The premix ingredients can be added in any order.

In a fifth aspect, a method is disclosed of preparing a fat free, non-dairy soft serve product from the fat free, non-dairy soft serve premixes described herein.

In one embodiment, a method of preparing a fat free, non-dairy soft serve product is disclosed comprising (i) introducing a fat free, non-dairy liquid soft serve premix of the present invention into a refrigerated storage tank of a soft serve machine maintained at a temperature from about 2° C. to about 4° C., and (ii) introducing the fat free, non-dairy liquid soft serve premix from the refrigerated storage tank and a volume of air into the freezer of the soft serve machine equipped with beaters and/or scraping blades, wherein the beaters and/or scraping blades continually blend the premix and air, thereby providing a fat free, non-dairy soft serve product.

In preferred embodiments, the air and liquid premix are introduced into the freezer from the refrigerated storage tank via a pump. In another embodiment, the air and liquid premix are introduced into the freezer via gravity.

The method can further include (iii) dispensing at least a portion of the fat free, non-dairy soft serve product. Some (i.e. a portion) or all of the fat free, non-dairy soft serve product prepared in the freezer can be dispensed for use. The soft serve product can be dispensed into bowls, cones, cups and the like.

In some embodiments, the premix in (i) is prepared from a fat free, non-dairy powder soft serve premix of the present invention. In one such embodiment, the method comprises first providing a fat free, non-dairy powder soft serve premix of the present invention and then adding a quantity of water, thereby providing a fat free, non-dairy liquid soft serve premix. In another such embodiment, the method comprises first providing a quantity of water and then adding the fat free, non-dairy powder soft serve premix, thereby providing a fat free, non-dairy liquid soft serve premix. The fat free, non-dairy liquid soft serve premix can then be carried through the steps outlined above to provide a fat free, non-dairy soft serve product.

The volume of air and hence overrun can be adjusted by methods known to those skilled in the art, e.g. by manipulating the air flow inlet opening to the freezer barrel.

### EXAMPLES

### Example 1: Strawberry Soft Serve

A strawberry soft serve premix (Formula 1575-079) was prepared using the following method. All ingredients were purchased from commercial sources.

Pectin and gum blends were solubilized in water with high shear and mixed for at least 5 minutes to provide a homogeneous solution. Fruit juice concentrates were then added and mixed well for 5 minutes. Natural colors and flavors were then added and mixed well for 5 minutes. A sample was then drawn to evaluate Brix and acidity. The Quillaja and Yucca Extracts were added using low speed agitation to mix well. High shear should be avoided. The resulting mixture was processed at 197° F. for 16 seconds, then cooled to less than 40° F. The resulting mixture was filled into sanitized form, fill and seal-type pouch (2 gallons) and stored at less than 40° C. until use

| Ingredient | % Formula | Functionality |
|---|---|---|
| Water | 68.8879 | Solubility |
| Apple Juice Concentrate | 1.6257 | Body and Mouthfeel |
| Pear Juice Concentrate | 4.8111 | Body and Mouthfeel |
| Strawberry Concentrate | 0.5693 | Flavor, Color, |
| | | Tartness |
| White Grape Juice Concentrate | 22.2655 | Body and Mouthfeel |
| Natural Flavors | 0.6107 | Flavor |
| Natural Fruit & Vegetable Extract | 0.1797 | Color |
| Quillaja Extract | 0.0300 | Foaming |
| Yucca Extract | 0.0300 | Foaming |
| Pectin | 0.4400 | Viscosity, Texture |
| Gum Acacia + Xanthan Gum | 0.5501 | Viscosity, Texture, |
| | | Emulsification |

A similar premix was prepared (Formula 1575-062) using the same ingredients and amounts with the exception of pectin (0.4%) and gum acacia/xanthan gum (0.5% total).

Strawberry soft serve products were prepared from both premix formulae using a Bench top Countertop Soft Serve Equipment. Spaceman Model 6228H. The overrun for each formula was determined using the following process, as shown in the table below.

In a clean cup with wide opening, the soft serve premix was filled to the top rim of the cup. The weight of the liquid premix in the cup was taken. The cup was then emptied, washed and dried. Soft serve product was then dispensed in the same cup and filled to the top rim. Excess was scraped from the top. Care was taken to avoid voids or air pockets. The weight of the soft serve product in the cup was then taken.

$$\% Overrun = \frac{\begin{matrix}weight of the liquid premix - \\ weight of the frozen soft serve product\end{matrix}}{weight of the frozen soft serve product} \times 100$$

Strawberry

| | | GA + Xanthan | | |
|---|---|---|---|---|
| Formula # | Pectin (%) | (%) | Ratio | % OR |
| 1575-062 | 0.4 | 0.5 | 0.80 | 65-68 |
| 1575-079 | 0.44 | 0.55 | 0.80 | 75-80 |

### Example 2: Mango Soft Serve

A mango soft serve premix (Formula 1575-078) was prepared using the same procedure as described in Example 1. All ingredients were purchased from commercial sources.

| Ingredient | % Formula | Functionality |
|---|---|---|
| Water | 63.6780 | Solubility |
| Citric Acid | 0.2593 | Tartness |
| Apple Juice Concentrate | 1.5594 | Body and Mouthfeel |
| Pear Juice Concentrate | 4.7284 | Body and Mouthfeel |
| Mango Puree Concentrate | 9.2240 | Flavor, Body, |
| | | Mouthfeel, Color |
| White Grape Juice Concentrate | 19.2383 | Body and Mouthfeel |
| Natural Flavors | 0.4010 | Flavor |
| Natural Annatto | 0.1660 | Color |
| Quillaja Extract | 0.0301 | Foaming |
| Yucca Extract | 0.0301 | Foaming |
| Pectin | 0.2937 | Viscosity, Texture |
| Gum Acacia + Xanthan Gum | 0.3917 | Viscosity, Texture, |
| | | Emulsification |

Two similar premixes were prepared using the same ingredients but different amounts of pectin and gum acacia/xanthan gum. Formula 1575-065 contained 0.26 wt % pectin and 0.34 wt % gum acacia/xanthan gum (total). Formula 1575-066 contained 0.29 wt % pectin and 0.38 wt % gum acacia/xanthan gum (total).

Mango soft serve products were prepared from all three premix formulae using a Bench top Countertop Soft Serve Equipment. Spaceman Model 6228H. The overrun for each formula was determined, shown in the table below.

Mango

| | | GA +Xanthan | | |
|---|---|---|---|---|
| Formula# | Pectin (%) | (%) | Ratio | % OR |
| 1575-065 | 0.26 | 0.34 | 0.75 | 40-50 |
| 1575-066 | 0.29 | 0.38 | 0.75 | 60-65 |
| 1575-078 | 0.29 | 0.39 | 0.75 | 70-75 |

### Example 3: Consumer Testing

The soft serve compositions of Examples 1 and 2 were evaluated during Centralized Location Test (CLT) to understand the consumer acceptance. The action standard for launch was that the prototype must achieve a mean overall liking score of 6.0 or higher on a scale of 1 to 9 with 1 being dislike extremely and 9 being like extremely.

### Study Design:

250 participants were pre-recruited for the study. Pasteurized soft serve mix was provided to the location. The mix was loaded into the soft serve dispenser before the beginning of the taste session, and soft serve product was dispensed for evaluation by the participants. The samples were evaluated in a sequential monadic rotated/balanced manner. Each participant was provided with about 4 oz of frozen soft serve in a cup and asked to consume at least ½ before answering the questions and continue consuming remaining amount while answering questions. Between two flavors, the participants were requested to eat ½-1 unsalted cracker and take a drink of water. The samples were evaluated for overall liking, taste, purchase intent, meets expectations, and pleasant aftertaste.

### Results and Discussion:

Both flavors were received very well by the participants. The overall liking score for mango prototype was 7.5, while that for strawberry prototype was 7.0. Both the flavors scored significantly higher than the action standard of 6.0. Both flavors performed almost equally and significantly higher than the action standard in the first position analysis (Table 1). “1^{st} Position” indicates population that sampled the particular flavor first. Half of the participants were given mango as their first sample and the remaining half of the participants were given strawberry as their first sample.

TABLE 1
Overall Liking¹

| | Mango | Strawberry |
|---|---|---|
| Total Sample | 7.4 A | 7.1 B |
| Convenience Retail Customer 1 | 7.5 A | 7.0 B |
| Convenience Retail Customer 2 | 7.2 A | 7.2 A |
| 1^{st} Position | 7.4 A | 7.3 B |

¹Overall liking assessed at 90% confidence level, one-tail

Mango was the preferred flavor from flavor intensity viewpoint, however, both flavors met expectations of a fruit based soft serve and the product description (Table 2).

TABLE 2
Product appearance, flavor, and mouthfeel attributes

| | | Mango | Strawberry |
|---|---|---|---|
| Appearance Liking | Total | 7.8 A | 8.0 A |
| (9 pt. scale; 1 = | 1^{st} Position | 7.9 A | 8.0 A |
| extremely dislike; 9 = | Convenience Retail | 7.8 A | 7.9 A |
| extremely like) | Customer 1 | | |
| | Convenience Retail | 7.8 B | 8.1 A |
| | Customer 2 | | |
| Mango/Strawberry | Total | 7.1 A | 5.9 B |
| Flavor Intensity | 1^{st} Position | 7.1 A | 6.0 B |
| (9 pt. scale; 1 = | Convenience Retail | 7.1 A | 5.8 B |
| Extremely Weak, 9 = | Customer 1 | | |
| Extremely Strong) | Convenience Retail | 7.1 A | 6.0 B |
| | Customer 2 | | |
| Mouthfeel (9 pt. | Total | 7.6 A | 7.1 B |
| scale; 1 = Dislike | 1^{st} Position | 7.5 A | 7.1 A |
| Extremely Weak, 9 = | Convenience Retail | 7.5 A | 7.1 B |
| Like Extremely) | Customer 1 | | |
| | Convenience Retail | 7.6 A | 7.1 B |
| | Customer 2 | | |

Significant difference at 95% confidence, two-tailed.
Different capital letters (A and B) represent statistically significant difference.

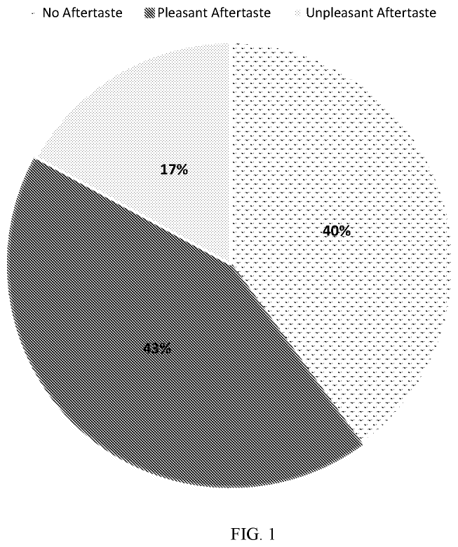

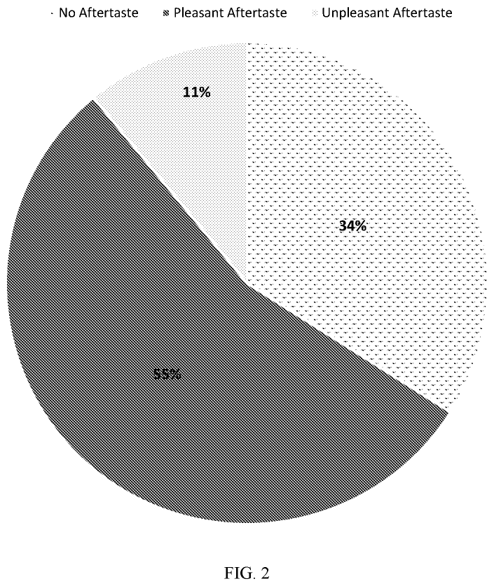

In addition to the overall liking, appearance, flavor, and mouthfeel, the participants found either a pleasant aftertaste or detected no aftertaste (FIG. 1. and FIG. 2.).

Both prototypes were also evaluated for agreement with the statements in Table 3. Each panelist was asked to rate their agreement with each statement on a scale of 1 to 5 (5=completely agree; 1=completely disagree). The percentage of panelists that rated a formulation with a 4 or 5 for the statement is provided in Table 3. Mango was preferred over strawberry.

TABLE 3
Frozen Novelty Consumers Attribute Agreement

| Statements | Mango | Strawberry |
|---|---|---|
| Is great tasting | 76% A | 63% B |
| Reminds me of a frozen soft serve treat | 78% A | 74% A |
| Is a nutritious snack | 50% A | 53% A |
| Is a meal replacement | 18% A | 19% A |
| Is a break in my day | 69% A | 57% B |
| Has a reasonable number of calories | 45% A | 46% A |
| Is a unique product | 73% A | 61% |
| Is something I would make a special visit for | 53% | 52% |

Significant difference at 95% confidence, two-tailed.
Different capital letters (A and B) represent statistically significant difference.

1. A fat free, non-dairy, soft serve premix comprising (i) at least one fruit juice concentrate, fruit puree concentrate or combination thereof; (ii) at least one plant extract rich in saponins, (iii) pectin and (iv) at least one thickener, wherein the weight ratio of pectin to at least one thickener is at least about 0.75.

2. The fat free, non-dairy, soft-serve premix of claim 1, wherein the fruit in (i) is selected from the group consisting of apple, apricot, avocado, banana, blackberry, black currant, blueberry, breadfruit, cantaloupe, carambola, cherimoya, cherry, clementine, coconut, cranberry, custard-apple, date, durian, elderberry, feijoa, fig, gooseberry, grapefruit, grape, guava, honeydew melon, jackfruit, java-plum, jujube fruit, kiwifruit, kumquat, lemon, lime, longan, loquat, lychee, mandarin, mango, mangosteen, mulberry, nectarine, orange, papaya, passion fruit, peach, pear, persimmon, pitaya (dragonfruit), pineapple, pitanga, plantain, plum, pomegranate, prickly pear, prune, pummelo, quince, raspberry, rhubarb, rose-apple, sapodilla, sapote, soursop, strawberry, sugar-apple, tamarine, tangerine, watermelon and combinations thereof.

3. The fat free, non-dairy, soft serve premix of claim 1, wherein the plant extract rich in saponins is selected from the group consisting of horse chestnut (Aesculis hipocastanum), oat (Avena sativa), sugar beet leaves (Beta vulgaris), quinoa (Chenopodium quinoa), chickpea (Cicer arietinum), saffron crocus (Crocus savitus), soybean (Glycine max), licorice root (Glycyrrhiza glabbra), ivy (Hedera helix), alfalfa (Medicago sativa), Chinese ginseng (Panax ginseng), American ginseng (Panax quinquefolius), green pea (Pisum sativum), milkwort (Polygala spp.), primula (Primula spp.), quillaja bark (Quillaja saponaria), soapwort (Saponaria officinalis), sarsaparilla (Smilax officinalis), fenugreek (Trigonellafoenum-graecum) and yucca (Yucca schidigera).

4. The fat free, non-dairy, soft serve premix of claim 1, wherein the pectin is high methoxyl pectin.

5. The fat free, non-dairy, soft serve premix of claim 1, the at least one thickener is selected from the group consisting of alginic acids, xanthan gum, guar gum, tara gum, locust bean gum, tamarind seed gum, psyllium seed gum, water-soluble soybean polysaccharide, gum arabic, tragacanth gum, karaya gum, pectin, gluco Mannan, carrageenan, agar, gellan gum, native gellan gum, curdlan, pullulan, macrohomopsis gum, rhamzan gum, methylcellulose (MC), hydroxypropylmethylcellulose (HPMC), cellulose derivatives such as sodium carboxymethylcellulose (CMC), microcrystalline cellulose and gellan gum.

6. (canceled)

7. A liquid soft serve premix comprising the fat free, non-dairy, soft serve premix of claim 1 and water.

8. A powder soft serve premix comprising the fat free, non-dairy, soft serve premix of claim 1, wherein the premix is dehydrated.

9. A fat free, non-dairy, soft serve product comprising (i) air; (ii) at least one fruit juice concentrate, fruit puree concentrate or combination thereof, (iii) at least one plant extract rich in saponins, (iv) pectin and (v) at least one thickener, wherein the weight ratio of pectin to at least one thickener is at least about 0.75 and the soft serve product has an overrun of at least about 70%.

10. The fat free, non-dairy, soft serve product of claim 8, wherein the fruit in (i) is selected from the group consisting of apple, apricot, avocado, banana, blackberry, black currant, blueberry, breadfruit, cantaloupe, carambola, cherimoya, cherry, clementine, coconut, cranberry, custard-apple, date, durian, elderberry, feijoa, fig, gooseberry, grapefruit, grape, guava, honeydew melon, jackfruit, java-plum, jujube fruit, kiwifruit, kumquat, lemon, lime, longan, loquat, lychee, mandarin, mango, mangosteen, mulberry, nectarine, orange, papaya, passion fruit, peach, pear, persimmon, pitaya (dragonfruit), pineapple, pitanga, plantain, plum, pomegranate, prickly pear, prune, pummelo, quince, raspberry, rhubarb, rose-apple, sapodilla, sapote, soursop, strawberry, sugar-apple, tamarine, tangerine, watermelon and combinations thereof.

11. The fat free, non-dairy soft serve product of claim 8, wherein the plant extract rich in saponins is selected from the group consisting of horse chestnut (Aesculis hipocastanum), oat (Avena sativa), sugar beet leaves (Beta vulgaris), quinoa (Chenopodium quinoa), chickpea (Cicer arietinum), saffron crocus (Crocus savitus), soybean (Glycine max), licorice root (Glycyrrhiza glabbra), ivy (Hedera helix), alfalfa (Medicago sativa), Chinese ginseng (Panax ginseng), American ginseng (Panax quinquefolius), green pea (Pisum sativum), milkwort (Polygala spp.), primula (Primula spp.), quillaja bark (Quillaja saponaria), soapwort (Saponaria officinalis), sarsaparilla (Smilax officinalis), fenugreek (Trigonellafoenum-graecum) and yucca (Yucca schidigera).

12. The fat free, non-dairy, soft serve product of claim 8, wherein the pectin is high methoxyl pectin.

13. The fat free, non-dairy, soft serve product of claim 8, wherein the at least one thickener is selected from the group consisting of alginic acids, xanthan gum, guar gum, tara gum, locust bean gum, tamarind seed gum, psyllium seed gum, water-soluble soybean polysaccharide, gum arabic, tragacanth gum, karaya gum, pectin, gluco Mannan, carrageenan, agar, gellan gum, native gellan gum, curdlan, pullulan, macrohomopsis gum, rhamzan gum, methylcellulose (MC), hydroxypropylmethylcellulose (HPMC), cellulose derivatives such as sodium carboxymethylcellulose (CMC), microcrystalline cellulose and gellan gum.

14. The fat free, non-dairy, soft serve product of claim 8, wherein the soft serve product has no sugar added.

15. The fat free, non-dairy, soft serve premix of claim 1 or the fat free, non-dairy, soft serve product of claim 8, further comprising one or more sweeteners.

16. The fat free, non-dairy, soft serve premix of claim 1 or the fat free, non-dairy, soft serve premix of claim 8, further comprising one or more flavor agents, color agents and/or fruit acids.

17. A method of preparing a fat free, non-dairy, soft serve product comprising:
a. introducing a fat free, non-dairy liquid soft serve premix into a refrigerated storage tank of a soft serve machine, wherein the fat free, non-dairy liquid soft serve premix comprises (i) water; (ii) at least one fruit juice concentrate, fruit puree concentrate or combination thereof; (iii) at least one plant extract rich in saponins, (iv) pectin and (v) at least one thickener, wherein the weight ratio of pectin to at least one thickener is at least about 0.75;
b. introducing the fat free, non-dairy liquid soft serve premix and a volume of air from the refrigerated storage tank into the freezer of the soft serve machine that is equipped with beaters and/or scraping blades, wherein the beaters and/or scraping blades continually blend the premix and air, thereby providing a fat free, non-dairy soft serve product; and
c. dispensing at least a portion of the fat free, non-dairy soft serve product.
